(19) United States
(12) Patent Application Publication
(10) Pub. No.: US 2017/0366674 A1
(43) Pub. Date: Dec. 21, 2017

(54) INMATE CALLING SYSTEM WITH GEOGRAPHIC REDUNDANCY

(71) Applicant: GLOBAL TEL*LINK CORP., Reston, VA (US)

(72) Inventor: Stephen L. HODGE, Aubrey, TX (US)

(21) Appl. No.: 15/184,338

(22) Filed: Jun. 16, 2016

(51) Int. Cl. H04M 7/00; H04L 29/06

(52) U.S. Cl. CPC H04M 7/006; H04L 65/1006; H04L 65/1069

(57) ABSTRACT

A geographically redundant inmate calling system is described. The geographically redundant inmate calling system includes two or more session border controllers that share session state information and provide for automatic failover in the event of the loss of availability of one session border controller. The geographically redundant inmate calling system eliminates any single point of failure such that communication services are highly available to inmates.

### BACKGROUND

### Field

The disclosure relates to high availability inmate calling systems. Specifically, this disclosure relates to inmate calling systems with geographic redundancy.

### Related Art

American prisons house millions of individuals in controlled environments all over the country. These prisoners are entitled to a number of amenities that vary depending on the nature of their crimes. Such amenities may include phone calls, video calls, and other forms of communication. Two primary categories of phone systems have evolved to serve the needs of inmate communications. In premise based call processing, inmate calling systems are located on the premise of the inmate facility that they serve. In centralized call processing, a single calling system is located remotely from any one inmate facility and is shared by multiple facilities. The latter approach of centralized call processing has become the most prevalent in the market today.

The advantages of premise based calling systems is that a failure of one system will only result in loss of service to the facility it serves. Other locations are unaffected by a single outage because each facility has its own call processing system. However, the disadvantage of premise based calling systems is the high cost of installation and maintenance involved with having many separate systems. In addition, premise based systems are tied to the power and communications capabilities of a single site, the facility they serve.

The advantage of centralized call processing systems is lower cost of installation and maintenance in serving a number of facilities with a single system. Centralized call processing systems also are often installed in data centers with redundant power and communications systems. However, centralizing the call processing for a number of facilities creates a single point of failure for all facilities. If an outage were to occur at one data center, dozens of facilities may suffer communications outages a result.

Outages of any calling system may be the result of a number of natural and technical causes. For example, loss of communications capabilities may be caused by a cut communication line as a result of digging. Similarly, power outages may be the result of natural phenomenon like storms or floods. Finally, equipment failure can happen at any layer of the calling system, including computing resources, communication resources such as routers, or power systems such as power distribution units or power converters.

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates an exemplary call processing system according to an embodiment;

FIG. 2 illustrates an exemplary call processing system according to an embodiment;

FIG. 3 illustrates an exemplary call processing system according to an embodiment;

FIG. 4 illustrates an exemplary call processing system according to an embodiment;

FIG. 5 illustrates an exemplary timing diagram of communication between session border controllers;

FIG. 6 illustrates an exemplary timing diagram of communication between session border controllers; and

FIG. 7 illustrates an exemplary general purpose computer system that can be used to implement parts of the call processing system.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

Embodiments may be implemented in hardware (e.g., circuits), firmware, computer instructions, or any combination thereof. Embodiments may be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices, or other hardware devices Further, firmware, routines, computer instructions may be described herein as performing certain actions. However, it should be appreciated that such descriptions are merely for convenience and that such actions in fact results from computing devices, processors, controllers, or other devices executing the firmware, routines, instructions, etc. Further, any of the implementation variations may be carried out by a general purpose computer, as described below.

For purposes of this discussion, the term “module” shall be understood to include at least one of hardware (such as one or more circuit, microchip, processor, or device, or any combination thereof), firmware, computer instructions, and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Those skilled in the relevant art(s) will recognize that this description may be applicable to many different communications types, and is not limited to voice calling or video calling.

As previous discussed, there are two main categories of inmate calling systems: centralized and on premise. Centralized call processing describes a system in which multiple locations use a single, or centralized, call processing system. The call processing system may be located remotely from any one location. Premise based call processing describes a system in which each location has its own call processing system. Each has its own advantages and disadvantages. Centralized call processing brings decreased cost of installation and administration due to the shared infrastructure but introduces a single point of failure for multiple facilities. On premise systems provide redundancy, that is, an outage of one system will only affect the location where it is located, but at a higher cost in deploying multiple call processing systems for multiple locations.

With these concerns in mind, it is preferable to have an inmate calling system that combines the cost efficiency of centralized call processing with the resiliency of on premise systems. Furthermore, it is preferable to have even increased availability over in premise systems such that service is never interrupted to inmate facilities. A preferred inmate calling system should eliminate any single point of failure such that communication services are highly available to inmates. With this objective in mind, the following description is provided of an inmate calling system with geographic redundancy. The architecture of this system has no single point of failure such that no outage at any one location or failure of any one piece of equipment will result in degradation of service provided to correctional facilities.

Exemplary Calling System with Geographic Redundancy

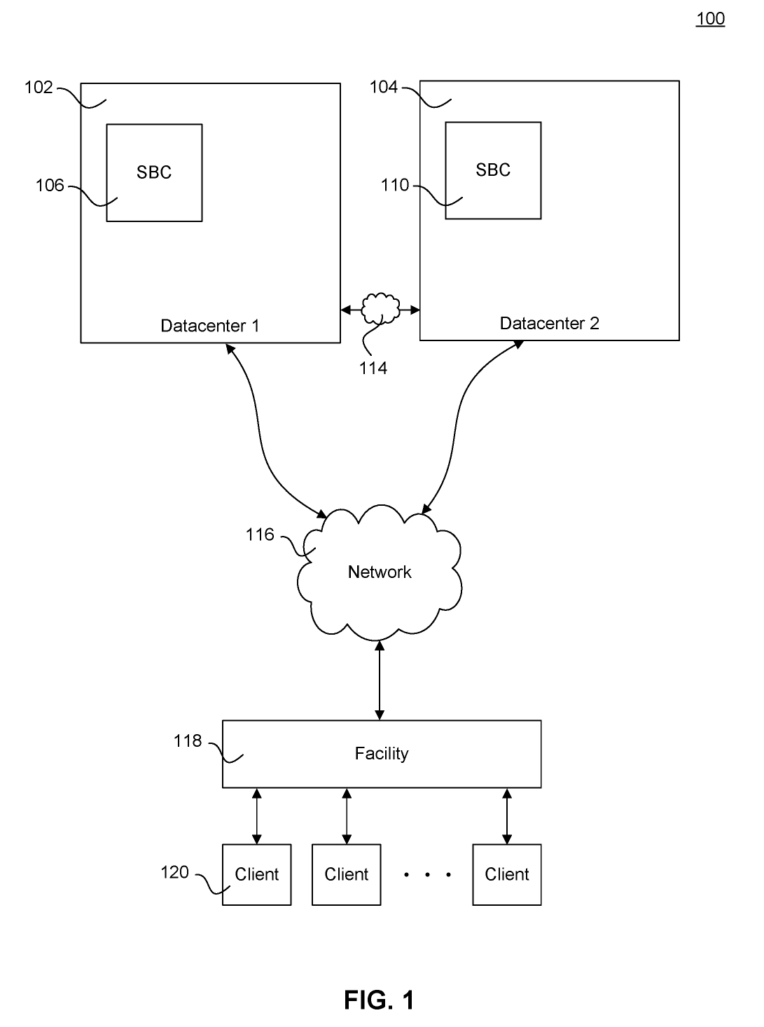

FIG. 1 illustrates an exemplary Inmate Calling System 100 according to an embodiment. In this embodiment, the inmate call processing system includes two datacenters 102 and 104. Each datacenter is located in a different geographical location, and has its own power and communication infrastructure. The two datacenters are located in, for example, two different cities. A failure caused by a local event at one datacenter will not affect the other datacenter. Failover between the two datacenters is managed by one or a combination of techniques described in more detail below in the section “Failover Techniques.”

Datacenter 102 and datacenter 104 are connected by a communication link 114. In an embodiment, communication link 114 is a route over the public internet, a virtual private network (“VPN”) operating on a public network, or a private network link. The datacenters are also connected to one or more inmate facilities by Network 116. In an embodiment, Network 116 is the same network that Communications Link 114 operates on. In another embodiment, Network 116 is separate from Communications Link 114. One example of Network 116 is the Internet. Inmate Facility 118 is also connected to Datacenters 102 and 104 by Network 116.

Some embodiments process calls using Voice Over Internet Protocol, or “VOIP.” VOIP is a technology which enables voice calling using the Internet Protocol, or “IP.” A VOIP client is, for example, in the form of a traditional phone with a handset and a base unit. Another example of a VOIP client is a software implementation in a computer system such as a handheld computer or a smartphone. Other VOIP client examples include kiosks and cellular implementations.

One example of a VOIP protocol is the Session Initiation Protocol. The Session Initiation Protocol (“SIP”) is a communications protocol for signaling and controlling multimedia communication sessions. The most common applications of SIP are in Internet telephony for voice and video calls, as well as instant messaging, over IP networks. The SIP protocol defines the messages that are sent between endpoints, which govern establishment, termination and other essential elements of a call. SIP can be used for creating, modifying and terminating sessions consisting of one or several media streams. SIP is an application layer protocol designed to be independent of the underlying transport layer.

Datacenters 102 and 104 each contain a Session Border Controller to process VOIP calls. A session border controller (“SBC”) is a device deployed in VoIP networks to exert control over the signaling and usually also the media streams involved in setting up, conducting, and tearing down telephone calls or other interactive media communications. Datacenter 102 contains SBC 106 and Datacenter 104 contains SBC 110.

The term “session” refers to a communication between two parties—in the context of telephony, this would be a call. Each call consists of one or more call signaling message exchanges that control the call, and one or more call media streams which carry the call's audio, video, or other data along with information of call statistics and quality. Together, these streams make up a session. It is the job of a session border controller to exert influence over the data flows of sessions.

In addition to SBCs, Datacenters 102 and 104 include one or more computers or servers to processes VOIP calls. In an embodiment, the one or more servers or computers are organized into one or more computer clusters or server clusters to process VOIP calls.

In operation, a VOIP Client 120 at Inmate Facility 118 connects to Datacenter 102 to process VOIP calls. Each Datacenter 102 and 104 contains its own SBC, 106 and 110, respectively. SBC 106 and 110 are in constant communication with one another via network 114. Network 114 may be the same or different network from Network 116. The SBCs share information pertaining to all current VOIP sessions. This enables one SBC to take over connections for the other in the event of a failover. If Datacenter 102 goes offline for any reason, a failover occurs and Datacenter 104 can take over providing VOIP connectivity to VOIP Client 120 at Inmate Facility 118.

Exemplary Inmate Calling System with Inter-Datacenter Redundancy

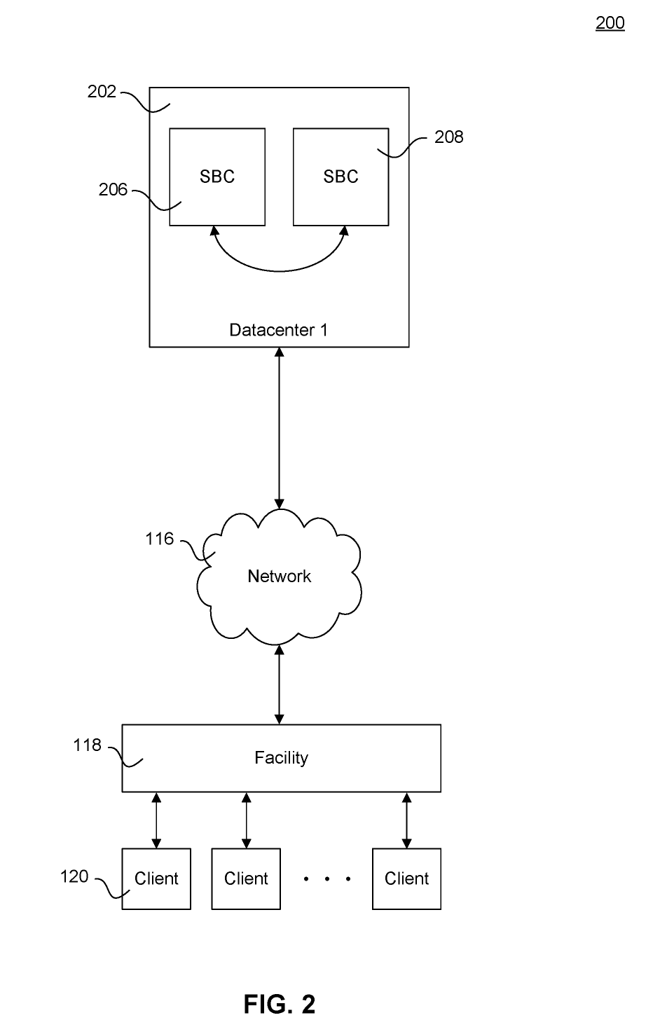

FIG. 2 illustrates an exemplary Inmate Calling System 200 according to an embodiment. In this embodiment, SBCs 206 and 208 are redundant within Datacenter 202. Within the Datacenter 202, the SBCs are redundant in the same way that SBCs are redundant across geographic zones. SBC 206 and 208 are connected via a network fabric and share all VOIP session state between each other. Within the Datacenter 202, if one SBC goes offline or becomes unavailable for any read, the other SBC takes over. This failover is accomplished by one or a combination of techniques described in more detail below in the section “Failover Techniques.”

Other redundancy in the datacenter includes power and connectivity redundancy. In an embodiment, power supply is provided from two or more sources. For example, a datacenter can have access to two or more power supply companies, provided on two or more power supply lines entering the datacenter. In addition, the datacenters have power backup solutions in the event of a power outage including but not limited to generator backup and battery backup systems.

Connectivity is provided from two or more connectivity providers on two or more connectivity lines. For example, a datacenter can have multiple upstream providers and multiple peering relationships with other networks. The multiple upstream connections are provided on physically distinct pathways into the datacenter building. For example, a datacenter may have one fiber optic cable entering the datacenter at one point, and another entering at the opposite side of the building.

Exemplary Inmate Calling System with Geographic Redundancy and Inter-Datacenter Redundancy

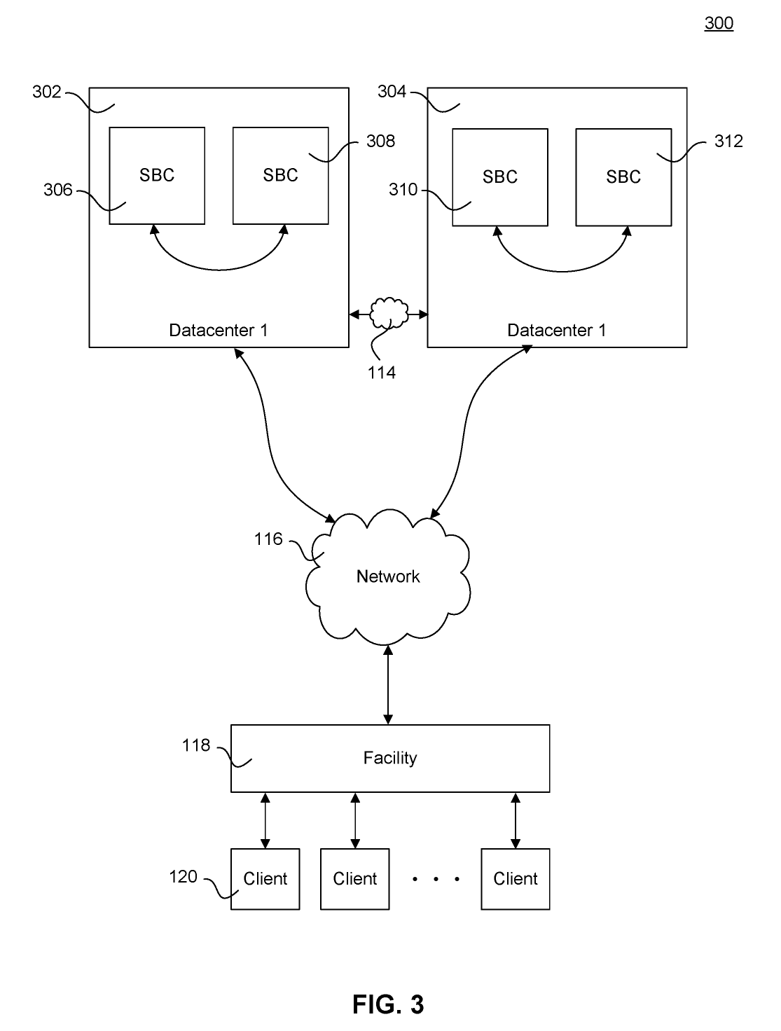

FIG. 3 illustrates an exemplary Inmate Calling System 300 according to an embodiment. In this embodiment, not only are the SBCs and other VOIP equipment redundant across Datacenter 302 and 304, but each datacenter includes redundant SBCs 306, 308, 310, and 312. The combination of inter-datacenter redundancy and geographic redundancy produces a highly available inmate calling system. All features of both the geographically redundant embodiment and the inter-datacenter embodiment are combined in this embodiment. The first level of failover occurs between the one or more SBCs and computer clusters within Datacenter 302. SBC 306 and 308 are connected via a network fabric and share all VOIP session states between each other. Within the Datacenter 202, if one SBC goes offline or becomes unavailable for any reason, the other SBC takes over. This failover is accomplished by one or a combination of techniques described in more detail below in the section “Failover Techniques.”

The next level of redundancy is between Datacenter 302 and 304. If the entire Datacenter 302 becomes unavailable for any reason, including both SBC 306 and 308, communications service is transferred via failover operation to Datacenter 304. This failover is also accomplished by one or a combination of techniques described in more detail below in the section “Failover Techniques.” In Datacenter 304, multiple SBCs 310 and 312 continue to provide VOIP connectivity in a similar way as SBCs 306 and 308. Therefore there is redundancy not only between datacenters, but also within each datacenter.

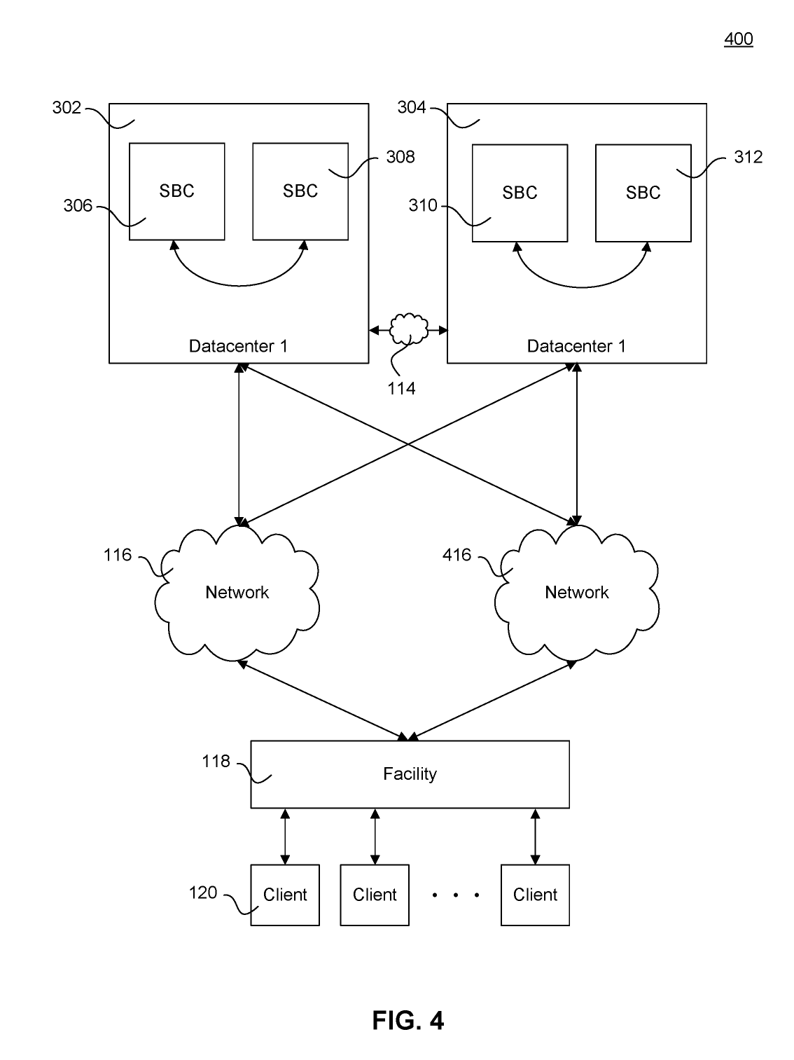

FIG. 4 illustrates an exemplary Inmate Calling System 400 incorporating all of the features of Inmate Calling System 300. In Inmate Calling System 400, another level of redundancy is introduced at the network level. Facility 118 is connected to two networks, Network 116 and Network 416. Similarly, both datacenters 302 and 304 are connected to both Network 116 and Network 416. This additional redundancy provides for fault resistance at the network level. If Network 116 becomes inoperative or unavailable, communications can continue via Network 416, or vice versa. In an embodiment, Networks 116 and 416 are both the Internet, but provided via different internet service providers. In another embedment, Networks 116 and 416 are different routes over the Internet. In another embodiment, Networks 116 and 416 are network connections with different physical connections, for example wired and wireless. For example, Network 116 could be a fiber optic connection, and Network 416 could be a wireless WAN link.

### Failover Techniques

With multiple datacenters and computing systems providing redundancy, the system requires some technique to manage failover in the case of an outage at any single point. For example, if two datacenters provide calling services and one goes offline, the clients of the calling services need to utilize the other datacenter, or failover. Several techniques are available to enable clients to failover from one datacenter to another. VOIP systems operate over the Internet Protocol (“IP”). IP utilizes IP addresses, commonly IPv4 or IPv6 addresses. IPv4 addresses consist of a 32-bit address, commonly represented in a quad-dotted notation where each component represents one byte of the address. An example of an IPv4 address is 151.207.128.53. IPv6 is the successor to IPv4 and consists of a 128-bit address commonly represented in eight groups of four hexadecimal digits separated by colons. An example of an IPv6 address is 2610:0020:5004:1604:0000:0000:0000:0133. Because these addresses are cumbersome for most people to remember and type, the Internet has what is called the Domain Name System (“DNS”). DNS is like a phone book that interprets human-readable names into IP addresses. For example, a DNS lookup for “uspto.gov” yields the IP address 151.207.128.53. Some embodiments of the calling system with geographic redundancy utilize DNS to provide failover between geographically redundant datacenters providing VOIP connectivity.

In an embodiment, the calling system registers multiple IP addresses per domain name such that all addresses are provided to clients in a DNS lookup. In this way, the addresses of multiple datacenters are provided to each VOIP client. The clients are programmed in such a way to attempt to connect to one IP address returned, and if unsuccessful, try another one. This configuration relies on VOIP clients that are aware of multiple DNS records and are programmed to traverse the returned list of IP addresses to find a functional VOIP endpoint.

Another embodiment that also utilizes the DNS system is referred to as round-robin DNS. In this embodiment, a DNS server maintains a list of multiple datacenters and returns one address from the list. The list is permutated on the DNS server such that only one addresses is returned to the client. In some variants of this embodiment the DNS server may employ a heartbeat, or availability check on the individual datacenter sites to determine if they should be removed from the round robin DNS record queue. The heartbeat, or availability check is a short message that confirms a resource is online and available. One example of a heartbeat is a “ping” message sent on the Internet Control Message Protocol (ICMP). Another example of a heartbeat is the retrieval of a small file or document via a standard internet protocol such as the Hypertext Transfer Protocol (HTTP). More elaborate heartbeat mechanisms are employed in other embodiments which convey information about the server to the DNS system such as uptime, load capacity and usage, and other server health related information. The DNS server can then use this information to make an intelligent decision about which server to direct new requests to.

Another embodiment involves the calling system hosting its own DNS server, and serving DNS records itself. This does not introduce a single point of failure because of the redundancy inherent in the DNS system. In this embodiment, the calling system can manage which IP address to provide VOIP clients based on any number of criteria, including availability and load. The downside to this approach is that DNS records propagate slowly through the DNS system, and downtime may occur when switching DNS record entries to point from one datacenter to another.

Yet another failover technique employed by some embodiments employ what is known as Anycast addressing. Anycast is a network addressing and routing methodology in which datagrams from a single sender are routed to the topologically nearest node in a group of potential receivers, though it may be sent to several nodes, all identified by the same destination address. Simply put, with Anycast, multiple machines can share the same IP address. When a request is sent to an Anycasted IP address, routers will direct it to the machine on the network that is closest. In this embodiment, two or more datacenters can share a single IP address and traffic from a VOIP client is automatically routed to the nearest datacenter. In these embodiments the DNS record only needs to have a single IP address entry.

Another failover technique employed by some embodiments relies on the client to automatically select a best endpoint. An example of this embodiment is having unique domain names for each datacenter, and instructing the clients to select from that list of domain names. This technique does not utilize DNS for failover, but gives the control to the client to make the decision of when and where to fail over to. If one address or domain name becomes unavailable to a client, the client will try another address or domain name. The advantage of this approach is the simplicity in design, it does not require advanced DNS techniques.

### Session Border Controller Information Sharing

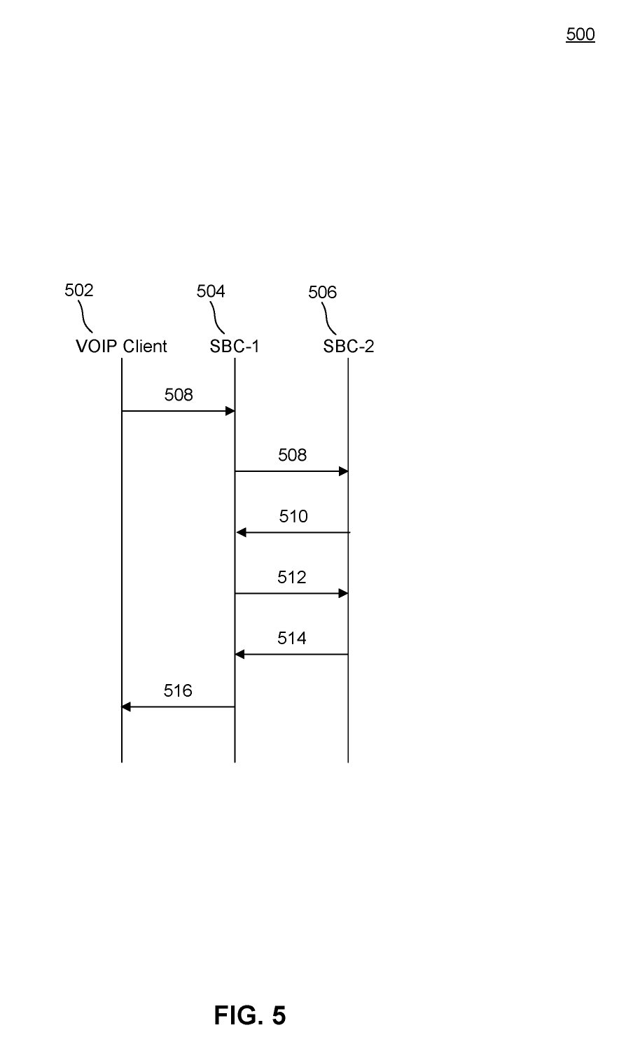

To enable automatic failover between SBCs, the SBCs need to share state data. This sharing of information between SBCs occurs both within the same datacenter and between different datacenters. FIG. 5 illustrates an exemplary state diagram for sharing data between two SBCs. At step 508, SBC 504 receives a request from a VOIP Client 502. SBC 504 first transmits this request, as received, to SBC 506 at step 508. At step 510, SBC 506 acknowledges receipt of the request. Next, SBC 504 processes the request after receiving acknowledgement 510 to produce a response. SBC 504 next transmits the response to SBC 506 at step 512. At step 514, SBC 506 acknowledges receipt of the response. Finally, SBC 504 transmits the response to the VOIP Client 502 at step 516.

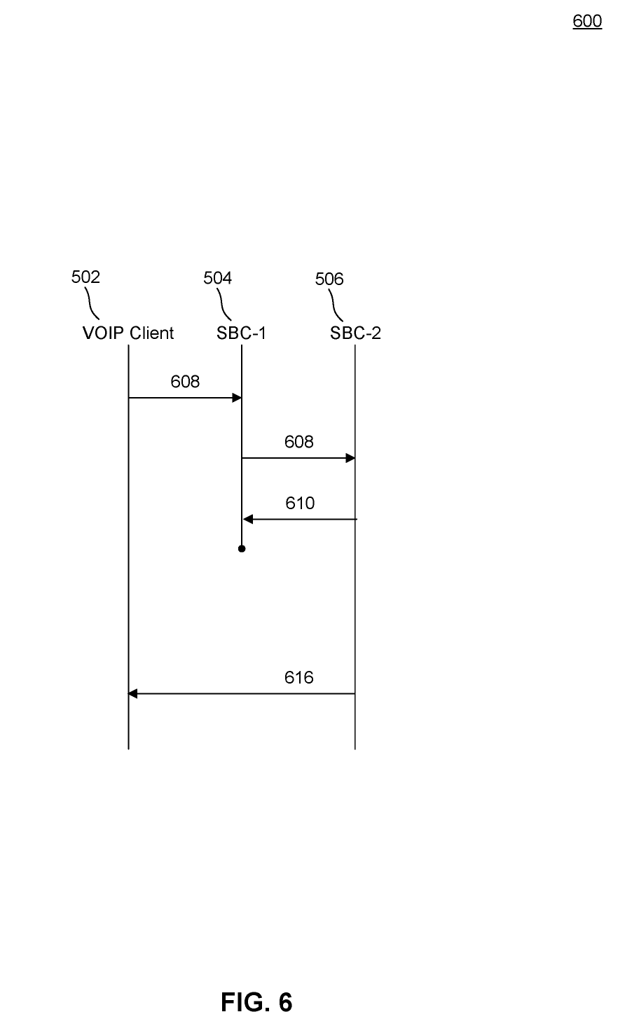

In this way, SBC 504 and SBC 506 stay fully synchronized, such that if SBC 504 is taken offline at any point in the call session, SBC 506 has all state information necessary to continue processing the call. For example, FIG. 6 illustrates the flow of information when SBC 504 goes offline in the middle of processing a request. At step 608, SBC 504 receives a request from a VOIP Client 502. SBC 504 first transmits this request, as received, to SBC 506 at step 608. At step 610, SBC 506 acknowledges receipt of the request. Next, SBC 504 is rendered unavailable. This unavailability could be caused by hardware failure, systems failure, software failure, or intentionally caused by taking the SBC offline for maintenance, for example. Because SBC 506 has the request as relayed in step 608, it can process the request and transmit the response to VOIP Client 502 at step 616.

In an alternative embodiment, the sharing of information between SBCs can be performed more efficiently by not requiring acknowledgement of each transaction before proceeding. For example, a first SBC can begin processing a request prior to receiving an acknowledgement from the second SBC that the previous state information has been received. In an embodiment, the acknowledgement of receipt between the two SBCs may be omitted entirely to further increase processing speed and efficiency. The synchronization between SBCs may be simply a one-way synchronization performed at intervals. Any loss of service between synchronization intervals may then potentially result in dropping communications. The trade-off of any of these asynchronous approaches is a lower guarantee of perfect synchronization between the two SBCs because the first SBC may go offline before the second SBC received all state information from the first SBC. This trade-off may be appropriate in some implementations of inmate calling systems because it reduces complexity and potentially increases processing speed at the SBCs. A person of ordinary skill in the art would recognize the various trade-offs between synchronization speed and completeness and other concerns such as efficiency and speed of execution, and be able to choose the right balance for any given implementation.

### Exemplary Computer System Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

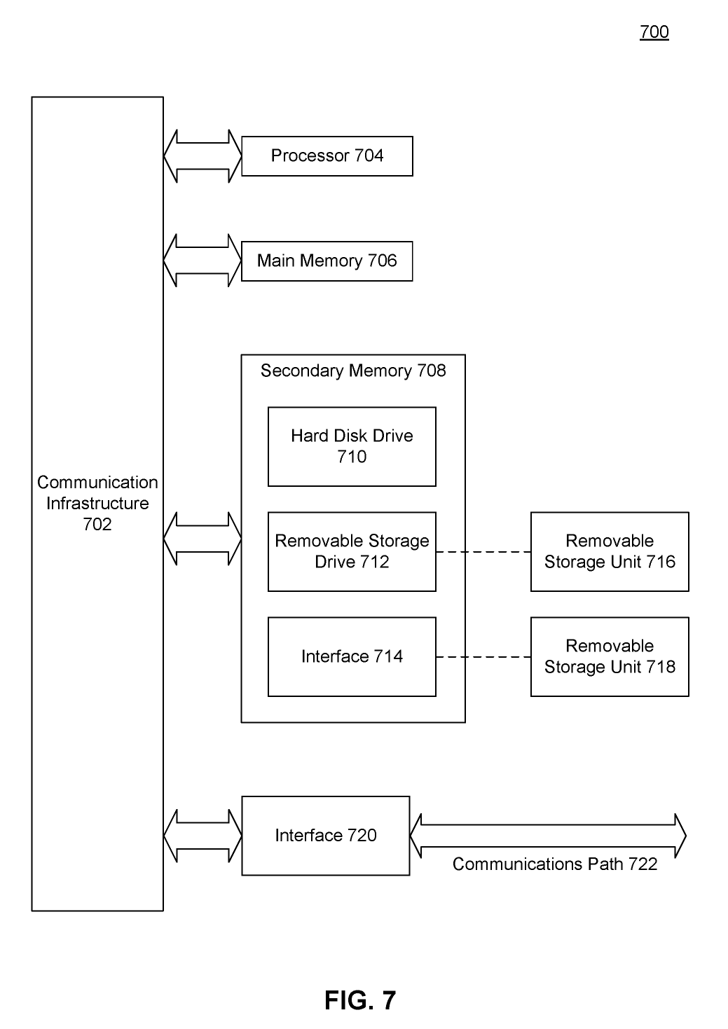

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 700 is shown in FIG. 7. One or more of the modules depicted in the previous figures can be at least partially implemented on one or more distinct computer systems 700.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 620. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure.

What is claimed is:

1. An inmate calling system for providing a call session to an inmate at an inmate facility, the inmate calling system comprising:
a first session border controller disposed within a first datacenter at a first location;
a second session border controller disposed within a second datacenter at a second location remote from the first location; and
an automatic failover mechanism configured to cause a calling client to automatically fail over from the first session border controller to the second session border controller in response to the first session border controller becoming unavailable to the client;
wherein both the first session border controller and the second session border controller are able to communicate with the calling client.

2. The system of claim 1, wherein the first session border controller and the second session border controller mediate voice over internet protocol (“VOIP”) calls to and from the calling client utilizing the session initiation protocol (“SIP”).

3. The system of claim 1, further comprising:
a domain name server that stores records for both the first session border controller and the second session border controller;
wherein the automatic failover mechanism is configured to change a domain name system record to direct internet protocol traffic to the second session border controller in response to detecting the first session border controller is unavailable to the calling client.

4. The system of claim 1, further comprising:
a third session border controller disposed within the first datacenter at the first location; and
a fourth session border controller disposed within the second datacenter at the second location;
wherein the automatic failover mechanism is further configured to:
cause the calling client to automatically fail over from the first session border controller to the third session border controller in response to the first session border controller becoming unavailable to the client, and
cause the calling client to automatically fail over from the second session border controller to the fourth session border controller in response to the second session border controller becoming unavailable to the client.

5. The system of claim 1, wherein the automatic failover mechanism is configured to cause the client to failover by rerouting call traffic from the client from the first session border controlled to the second session border controller.

6. The system of claim 1, wherein the automatic failover mechanism utilizes anycast routing.

7. The system of claim 1, wherein the first and second session border controller are in network communication with each other and share session state information.

8. A method for communications failover in an internet protocol client located at an inmate facility between a first session border controller and a second session border controller remotely located from the first session border controller, the method comprising:
establishing a communication session between the internet protocol client and the first session border controller;
in the internet protocol client located at the inmate facility, detecting a loss of communication with the first session border controller;
in response to the detecting a loss of communication with the first session border controller in the internet protocol client located at the inmate facility, establishing communication with the second session border controller remotely located from the first session border controller; and
continuing the communication session between the internet protocol client located at the inmate facility and the second session border controller.

9. The method of claim 8, wherein the detecting a loss of communication with the first session border controller includes detecting communication latency above a threshold between the internet protocol client located at the inmate facility and the first session border controller.

10. The method of claim 8, wherein the detecting a loss of communication with the first session border controller includes receiving a message from the first session border controller indicating to the internet protocol client located at the inmate facility to use an alternate session border controller to continue the communication session.

11. The method of claim 8, further comprising:
in the internet protocol client located at the inmate facility, detecting a loss of communication with the second session border controller;
in response to the detecting a loss of communication with the second session border controller in the internet protocol client located at the inmate facility, establishing communication with a third session border controller remotely located from the first and second session border controllers; and
continuing the communication session between the internet protocol client located at the inmate facility and the third session border controller.

12. The method of claim 8, wherein the internet protocol client is a voice over internet protocol client and the communication session between the voice over internet protocol client and the first session border controller is voice over internet protocol communication session utilizing the session initiation protocol, and the communication session between the voice over internet protocol client and the second session border controller is voice over internet protocol communication session utilizing the session initiation protocol.

13. The method of claim 8, wherein the communications sessions is a voice communications session using the session initiated protocol (“SIP”).

14. The method of claim 8, wherein the communications sessions is a video communications session.

15. A method of sharing data between a first session border controller providing a call session to an inmate of an inmate facility utilizing a voice over internet protocol (“VOIP”) client and a second session border controller, the method comprising:
receiving at the first session border controller a request from the VOIP client;
the first session border controller transmitting a copy of the request to the second session border controller;
receiving an acknowledgement from the second session border controller that the copy of the request was received;
processing the request at the first session border controller to produce a response;
the first session border controller transmitting a copy of the response to the second session border controller;
receiving an acknowledgement from the second session border controller that the copy of the response was received;
transmitting the response to the voice over internet protocol client.

16. The system of claim 15, wherein the request is a session initiated protocol (“SIP”) request and the response is a SIP response.

17. The system of claim 16, wherein the call session is a voice call session.

18. The system of claim 15, wherein the first session border controller is geographically remote from the second session border controller.

19. The system of claim 15, wherein the first session border controller and the second session border controller are disposed within the same datacenter.

20. The system of claim 15, wherein the first session border controller and the second session border controller communicate with each other via a private network.
